(19) United States
(12) Patent Application Publication
(10) Pub. No.: US 2001/0028912 A1
(43) Pub. Date: Oct. 11, 2001

(54) Cheese product and method of manufacturing same

(76) Inventors: Anno Kaiser, Fischwgen (DE); Klaus Rolf Wernecke, Goetting (DE); Rainer Zartner, Cluvenhagen (DE)

Correspondence Address: FITCH EVEN TABIN AND FLANNERY, 120 SOUTH LA SALLE STREET, SUITE 1600, CHICAGO, IL, 606033406

(21) Appl. No.: 09/791,352

(22) Filed: Feb. 23, 2001

Related U.S. Application Data
(63) Continuation of application No. PCT/EP99/02628, filed on Apr. 19, 1999.

(30) Foreign Application Priority Data
Aug. 25, 1998 (EP) 98116029.4

(51) Int. Cl. A23C 19/00

(52) U.S. Cl. 426/582; 426/517; 426/502

(57) ABSTRACT

The present invention relates to a novel cheese product comprising a number of stacked cheese layers with at least one partition extending from the top layer towards the bottom layer. The invention also relates to a method of manufacturing said novel cheese product and its use for decoration or in snack foods.

The present invention is concerned with a novel cheese product and a method for its production.

Cheese products are commonly sold in discreet units, namely in the for of blocks, slices or in gratinated form. While cheese blocks and slices exhibit a defined shape, they suffer from the drawback that they are provided in non-variable preset units. These preset units are not adapted to particular purposes, such as decorative uses, snack foods and the like. Even though it is possible to cut blocks or slices of cheese according to particular needs, the adaptation to particular purposes requires additional labour and, often times, leads to left over cheese which cannot be otherwise used.

Gratinated cheese, on the other hand, allows for the use of varying amounts of cheese but lacks a defined shape, which renders it widely unsuitable for, e.g., decorative or snack purposes.

It is thus the object of the present invention to provide a cheese product with a defined shape which can easily be portioned according to individual needs.

This object is met by the cheese product according to the present invention. It comprises a number of stacked cheese layers with at least one partition extending from the top layer towards the bottom layer.

This novel structure of the cheese product according to the present invention allows easy portioning of the cheese product, while it simultaneously has a defined shape. The sections created by the layer structure and the at least one partition can be peeled off from the cheese product individually, or in groups of two or more, or the cheese product may be used as a whole. It thus constitutes a versatile product which is particularly suitable for decorative purposes and as a snack food or in snack foods. Especially in the latter case, the numerous possibilities of removing one or more sections from the cheese product is of particular advantage as it renders the product less solid and, thus, more appealing to the consumer. It also allows the consumer to playfully enjoy the cheese product in a variety of ways.

The cheese product according to the present invention comprises a number of stacked cheese layers with at least one partition extending from the top layer towards the bottom layer.

The product is thereby not limited as to its basic shape. That is, it may be provided as a stack with a rectangular, cross-section, a coin-shaped stack or in any other form. The product is also not limited as to the number of layers, even though products with three or more and, in particular, six or more layers are preferred.

There is also no limitation as to the number of partitions extending from the top towards the bottom layer. The partition in the cheese product according to the present invention is e.g. a cut extending from the top layer of the cheese stack towards the bottom layer thereof. It may extend through the entire stack or only through some layers thereof.

For the ease of manufacturing the at least one partition is preferably perpendicular to the cheese layer plane. However, the at least one partition may also be effected in an angle to said plane that is different from 90°. In embodiments with more than one partition, the planes of the partitions need not be parallel.

By varying the number of layers and the number of partitions as well as their depth and angle, the cheese product according to the present invention can easily be adjusted according to varying needs.

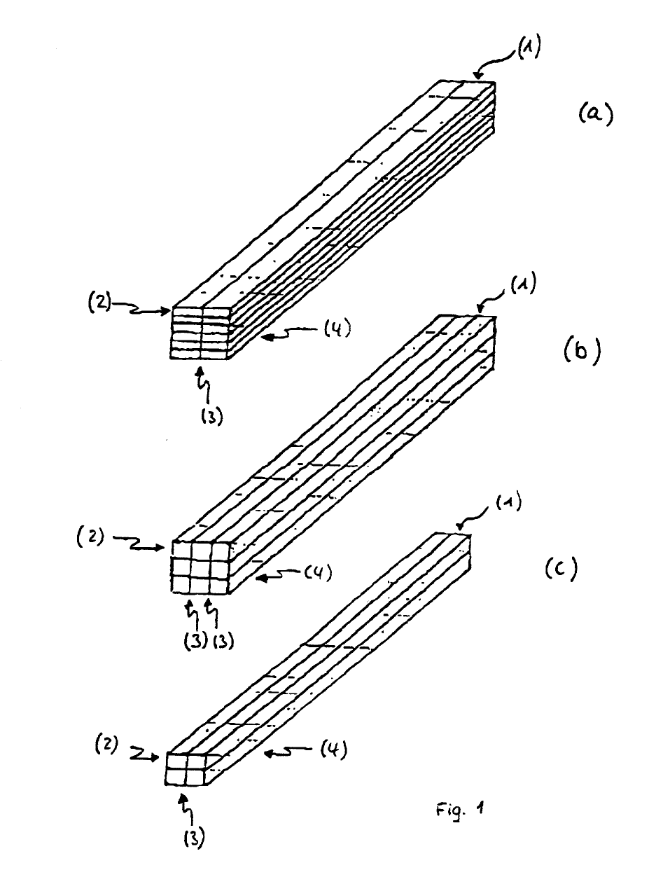

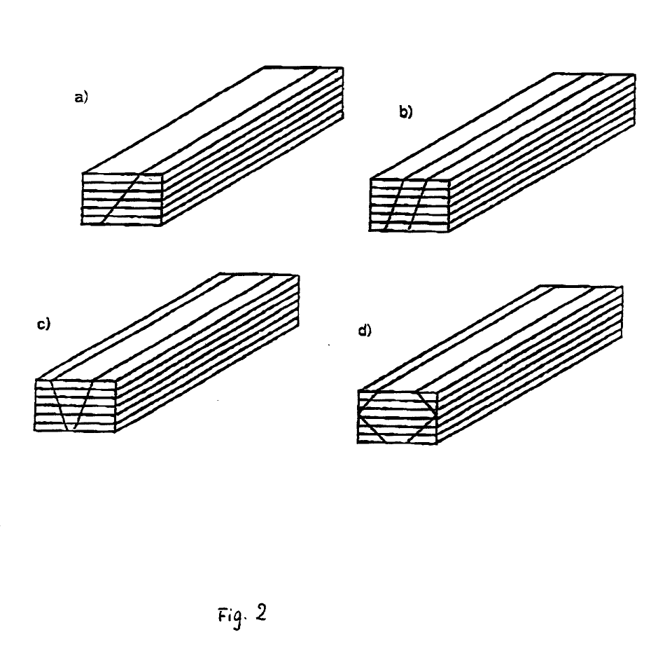

In a preferred embodiment, the cheese product according to the present invention is provided as a snack food. That is, the cheese product is provided as a partitioned stack of cheese layers with dimensions commonly used for snack foods, such as chocolate bars and the like. In this preferred embodiment, the shape of the cheese product is preferably that of a snack with a rectangular cross-section as illustrated in FIGS. 1 and 2.

FIG. 1 shows illustrative examples (a), (b) and (c) of the cheese product (1) of the present invention wherein the partition is perpendicular to the cheese layer plane. The cheese layers carry the reference number (2), and the partition the reference number (3). As shown in FIG. 1, the cheese product according to the present invention, by virtue of the partition (3), can also be described as comprising individual stacks (4), at least two of which are contacted via a surface perpendicular to the cheese layers,

FIG. 1 (a) is illustrative of a cheese product according to the present invention comprising six layers and a single partition. FIG. 1 (b) is illustrative of a cheese product according to the present invention with three layers and two partitions and FIG. 1 (c) is illustrative of a cheese product comprising two layers and one partition. It can moreover be noted from FIG. 1 that the individual sections obtained by stacking the cheese layers and effecting the perpendicular partition may have a rectangular or square cross-section.

FIG. 2 is illustrative of embodiments of the product according to the present invention wherein the at least one partition is effected in an angle different from 90° with respect to the cheese plane. Embodiments a) and b) in FIG. 2 provide for segments of varying size. This is also true in view of embodiments c) and d). In addition embodiments c1 and d) bear the advantage that units comprising more than one segment can be peeled off, which have different shapes. This renders the product even more versatile and also adds to the play-value of the product.

If the cheese products according to the present invention, such as those illustrated in FIGS. 1 and 2, are to be provided as snacks, their dimensions must be adjusted accordingly. That is to say, in the case where the snack food is provided e.g. as a body with a rectangular cross-section, its breath and height may preferably vary from 5 to 500 mm, more preferably from 10 to 20 mm,; and its length may vary from preferably 5 to 150 mm, more preferably prom 50 or 80 to 100 mm.

The cheese used for the cheese product according to the present invention is not particularly limited as to its type, but it should be of sufficient strength and elasticity so that the individual sections are peelable from the cheese product over the projected shelf life. In a preferred embodiment, the cheese product according to the present invention comprises process cheese.

When process cheese is used for the cheese product according to the present invention, the process cheese may contain 30 to 70 wt. %, preferably 35 to 65 wt.-% and in particular 57 to 62 wt.-% dry matter.

with respect to the dry matter the process cheese for the cheese product according to the invention may contain 0 to 75 wt.-%, preferably 5 to 70 wt.-% and in particular 38 to 45 wt.-% of one or more fat components.

The pH of the process cheese mass may be in the range of 4,5 to 7,0, preferably 5,0 to 6,5 and in particular 5.5 to 5.9.

The protein content may amount to 5 to 40 wt.-%, better 7 to 30 wt.-%, preferably 17 to 25 wt. % and in particular 22 to 25 wt.-% based on the weight of product.

Lactose may be present in an amount of 0 to 15 wt.-%, better 0 to 10 wt.-%, is preferably 1 wt.-% or less and in particular 0,05 to 0,25 wt.-%.

The amount of melting salt, e.g. citrate is preferably in the range from 2 to 4 wt.-%. It is preferable to use as little citrate melting salt or melting salt in general as possible

A process cheese according to the present invention may contain:

0-98 wt.-% cheese;

0-50 wt.-% butter;

0-40 wt.-% labcasein;

0-5 wt.-% melting salt and

0-10 wt.-% hydrocolloids and/or starch.

In a preferred embodiment the cheese contains:

15-85 wt.-% cheese;

0-40 wt.-% butter;

0-25 wt.-% labcasein;

1-4 wt.-% melting salt and

0-5 wt.-% hydrocolloids and/or starch.

In a particularly preferred embodiment the cheese contains:

70-85 wt.-% cheese;

2-4 wt.-% butter;

2-6 wt.-% labcasein and

2-4 wt -% citrate.

With respect to product stability and peelability as well as the overall balance of properties the following composition has proved to be very well suited:

75-85 wt.-% cheese;

2,2-2,6 wt.-% butter;

4,5-5,0 wt.-% labcasein and

2,5-3,0 wt.-% melting salt.

In addition to the listed ingredients, all of the above-exemplified compositions may also contain additional ingredients common in the art of making process cheese. The balance is water.

As hydocolloids useful for the present invention, the following may be exemplified: carob flour, guar flour, carrageeran, xanthan, gum arabic, alginates, pectins and cellulose such as carboxy methyl cellulose. Starch or starch derivatives can also be used instead or in addition to the hydrocolloid component.

When using process cheese for the cheese product according to the present invention, then the individual cheese layers may be produced according to methods commonly known for the manufacture of process cheese. In such processes, the starting materials are admixed and melted. The hot viscose melt is then processed into a continuous band of cheese with a preset thickness. This is commonly and suitably done by using an appropriate number of rollers or belts which, at the same time, may effect the cooling of the melt and, thus, the solidification of the processed cheese. In order to obtain the cheese product according to the present invention, one then needs to cut the thus produced continuous band of cheese, fort a stack of the thus obtained cuts and to effect the partition Effecting the partition and the stacking may, of course, be performed in either order. The thus prepared cheese product according to the present invention may then be packed in a conventional manner.

In a particularly preferred embodiment of the process according to the present invention, the cooling of the process cheese is effected in such a way that as little as possible moisture and, in particular, moisture of condensation is produced. In the case where rollers or belts are being used for cooling purposes, this can be achieved by removing moisture from the rollers or belts, e.g. by contacting them to drying means such as salt-filled bags. It is also possible to effect the cooling in a dry or preferably dried atmosphere with suitably 40 to 45% relative humidity. Avoiding to the largest possible extent the presence of moisture and, in particular, the formation of moisture of condensation in the cooling step serves to maintain the peelability of the individual sections in the final cheese product.

The above process according to the present invention can, of course, be modified in many ways, e.g., in order to produce a particular appearance of the cheese product. One-particular way of modifying the appearance of the cheese product involves the addition of a colorant such as carotin, to the process cheese just before or during the cooling operation. In particular, when using rollers for cooling, one may foresee means for supplying the colorant, which means moves along the axis of the cooling roller or belt. This arrangement leads to an uneven distribution of the color in the final cheese product and, thus, creates a marble-like appearance of the cheese product according to the present invention.

The cheese product according to the present invention can, of course also be provided with different flavours such as pizza, ham, smoked bacon and the like. Herbs can also be admixed to provide for a particular taste and appearance. It is also possible to use more than one type of cheese in a single cheese product according to the invention, whereby the cheese may differ e.g. in its color and/or flavour.

We claim:

1. Cheese product comprising a number of stacked cheese layers with at least one partition extending from the top layer towards the bottom layer.

2. Cheese product according to claim 1, wherein the cheese layers have a rectangular cross-section.

3. Cheese product according to claim 1, wherein the cheese layers comprise process cheese.

4. Cheese product according to claim 2, wherein the cheese layers comprise process cheese.

5. Cheese product according to claim 1, wherein the cheese layers have the following composition:
70-85 wt. % cheese;
2-4 wt.-% butter;
2-6 wt.-% labcasein;
2-4 wt.-% citrate;
balance of water.

6. Cheese product according to claim 2, wherein the cheese layers have the following composition:
70-85 wt. % cheese;
2-4 wt.-% butter;
2-6 wt.-% labcasein;
2-4 wt.-% citrate;
balance of water.

7. Cheese product according to claim 3, wherein the cheese layers have the following composition:
70-85 wt. % cheese;
2-4 wt.-% butter;
2-6 wt.-% labcasein;
2-4 wt.-% citrate;
balance of water.

8. A process for manufacturing a cheese product according to claim 5, comprising the steps of:
(i) admixing and melting the ingredients,
(ii) forming a cheese layer from the melt,
(iii) cooling the layer, and
(iv) stacking two or more layers and providing the at least one partition in any order.

9. A process for manufacturing a cheese product according to claim 6, comprising the steps of:
(i) admixing and melting the ingredients,
(ii) forming a cheese layer from the melt,
(iii) cooling the layer, and
(iv) stacking two or more layers and providing the at least one partition in any order.

10. A process for manufacturing a cheese product according to claim 7, comprising the steps of:
(i) admixing and melting the ingredients,
(ii) forming a cheese layer from the melt,
(iii) cooling the layer, and
(iv) stacking two or more layers and providing the at least one partition in any order.

11. A process according to claim 8, whereby, in the cooling step, the presence of moisture and/or the formation of moisture of condensation is avoided.

12. A process according to claim 9, whereby, in the cooling step, the presence of moisture and/or the formation of moisture of condensation is avoided.

13. A process according to claim 10, whereby, in the cooling step, the presence of moisture and/or the formation of moisture of condensation is avoided.

14. A process according to claim 8, wherein a colorant is non-uniformly dispersed in the cheese.

15. Snack food comprising a cheese product according to claim 1.

16. Snack food comprising a cheese product according to claim 2.

17. Snack food comprising a cheese product according to claim 3.

18. Sales package comprising a cheese product according to claim 2 or a snack food according to claim 15.

19. Use of a cheese product according to claim 1 for decoration or in snack foods.

20. Use of a cheese product according to claim 3 for decoration or in snack foods.
